(19) United States
(12) Patent Application Publication
(10) Pub. No.: US 2024/0264338 A1
(43) Pub. Date: Aug. 8, 2024

(54) PRISM SHEET, DIFFUSION SHEET AND DISPLAY APPARATUS

(71) Applicant: LG Display Co., Ltd., Seoul (KR)

(72) Inventors: Mihyung CHIN, Gwangmyeong-si (KR); Hyeran PARK, Gwangmyeong-si (KR); Nam KI, Seoul (KR)

(21) Appl. No.: 18/500,816

(22) Filed: Nov. 2, 2023

(30) Foreign Application Priority Data
Jan. 31, 2023 (KR) 10-2023-0013299

(51) Int. Cl. G02B 5/04; G02B 1/04; G02B 5/02; G02F 1/1335

(52) U.S. Cl. CPC G02B 5/045; G02B 1/04; G02B 5/0242; G02B 5/0268; G02F 1/133504; G02F 1/133607

(57) ABSTRACT

A prism sheet of an embodiment comprises a support layer, and prism patterns being disposed on the upper surface of the support layer, and the support layer may be comprised of a base resin comprising a homo PET, and a recycled copolymerized PET (Co-PET).

### CROSS-REFERENCE TO RELATED APPLICATION

This application claims priority to and benefit of Korean Patent Application No. 10-2023-0013299 filed on Jan. 31, 2023, which is hereby incorporated by reference as if fully set forth herein.

### BACKGROUND

### Technical Field

The present disclosure relates to a prism sheet, a diffusion sheet and a display apparatus. In particular, the present disclosure relates to an environmentally friendly prism sheet, diffusion sheet and display apparatus.

### Description of the Related Art

Examples of a flat panel display apparatuses comprise a liquid crystal display apparatus, an organic light-emitting display apparatus, an inorganic light-emitting display apparatus, a quantum dot display apparatus, and the like.

A liquid crystal display apparatus has a liquid crystal panel where a liquid crystal layer is interposed between two substrates, as an essential component, and supplies an electric field to the liquid crystal panel and changes an arrangement direction of a liquid crystal molecule, to embody a difference in transmittance.

However, since the liquid crystal panel does not have a self light-emitting component, the liquid crystal panel needs an additional light source, to express a difference in liquid crystal transmittance as an image, and to this end, a back light unit having a light source is disposed under the liquid crystal panel.

### BRIEF SUMMARY

A back light unit of a liquid crystal display apparatus is provided with a plurality of optical sheets that comprises one or more diffusion sheets and prism sheets to improve luminance of light output from a light source. Each of the plurality of optical sheets comprises an optical part on a support layer, to collect light or diffuse light.

For the support layer, a polyethylene terephthalate (PET) base material is most commonly used, and such PET base material accounts for a considerable portion of the cost of the optical sheet.

In fact, the PET base material used for an optical sheet is not recyclable, and after it is used, is thrown away and burned or buried. The burned or buried PET base material causes environmental pollution.

To prevent or reduce the environmental pollution, the inventors of the present disclosure invented a prism sheet and a diffusion sheet using a recycled PET.

One objective of the present disclosure is to provide a prism sheet and a diffusion sheet that help to reduce environmental pollution.

Another objective of the present disclosure is to provide an environmentally friendly display apparatus that helps to reduce environmental pollution.

Objectives of the present disclosure are not limited to the above ones, and other objectives that are not mentioned above can be clearly understood from the following description by one having ordinary skill in the art.

A prism sheet of one embodiment may comprise a support layer, and prism patterns being disposed on the upper surface of the support layer, and the support layer may be comprised of a base resin comprising a homo PET, and a recycled copolymerized PET (Co-PET).

A diffusion sheet of one embodiment may comprise a support layer, and a diffusion layer being disposed on the upper surface of the support layer and comprising beads, and the support layer may be comprised of a base resin comprising a homo PET, and a recycled Co-PET.

A display apparatus of one embodiment may comprise a liquid crystal panel, and a back light unit being disposed under the liquid crystal panel and comprising at least one of optical sheets, and at least one of the optical sheets may comprise at least one of the prism sheet according to one embodiment of the present disclosure, or the diffusion sheet according to one embodiment of the present disclosure.

Other particulars of embodiments are provided in the detailed description and the drawings.

According to embodiments, in a prism sheet, a base resin comprising a recycled Co-PET is used as a support layer, ensuring a reduction in manufacturing costs of the prism sheet, and a contribution to recycling of resources and protection of the environment.

According to embodiments, in a diffusion sheet, a base resin comprising a recycled Co-PET is used as a support layer, ensuring a reduction in manufacturing costs of the diffusion sheet, and a contribution to recycling of resources and protection of the environment.

According to embodiments, a display apparatus comprises a prism sheet and a diffusion sheet where a base resin comprising a recycled Co-PET is used as a support layer, ensuring a reduction in manufacturing costs of the display apparatus, and a contribution to recycling of resources and protection of the environment.

Aspects according to the present disclosure are not limited to the above ones, and other aspects and advantages that are not mentioned above can be clearly understood from the following description by one having ordinary skill in the art.

### BRIEF DESCRIPTION OF THE SEVERAL VIEWS OF THE DRAWINGS

The accompanying drawings constitute a part of the specification, illustrate one or more embodiments in the disclosure, and together with the specification, explain the disclosure, wherein:

FIG. 1 is a view showing a prism sheet according to one embodiment of the present disclosure;

FIG. 2 is a view showing a prism sheet according to one embodiment of the present disclosure;

FIG. 3 is a view showing a diffusion sheet according to one embodiment of the present disclosure; and

FIG. 4 is an exploded perspective view showing a display apparatus according to one embodiment of the present disclosure.

### DETAILED DESCRIPTION

Advantages and features in the present disclosure and a method of ensuring the same can be clearly understood from embodiments that are described hereafter with reference to accompanying drawings. The subject matter of the disclosure, however, can be embodied in various different forms, and should not be construed as being limited to the embodiments set forth herein. Rather, the embodiments are provided as examples so that the disclosure can be thorough and complete and can fully convey the scope of the disclosure to one having ordinary skill in the art.

The shapes, sizes, ratios, angles, number and the like of the components illustrated in the drawings provided for describing the embodiments of the disclosure are given only as examples, and the subject matter of the disclosure is not limited by the particulars in the drawings. Throughout the disclosure, like reference numerals denote like components. In describing the subject matter, detailed description of well-known technologies relevant to the disclosure is omitted if it is deemed to make the gist of the disclosure unnecessarily vague. Throughout the disclosure, terms such as “comprise,” “have,” “being comprised of” and the like are to imply the inclusion of any other component, but for a term such as “only.” Further, the singular forms “a,” “an” and “the” are intended to include the plural forms as well, unless explicitly stated otherwise.

In describing a component, the margin of error is to be included, though not explicitly described.

In the disclosure, when spatial terms such as “being on,” “being in an upper portion,” “being in a lower portion,” “being adjacent to” and the like are used to describe a position relationship between two components, one or more additional components can be interposed between the two components unless terms such as “right” or “directly” are used.

In describing components, terms such as first, second and the like can be used. These terms are only intended to distinguish one component from another component, and the components are not limited by such terms. Accordingly, a first component described hereafter can be a second component within the technical spirit of the disclosure.

Throughout the disclosure, identical reference numerals can denote identical components.

The size and thickness of each component in the drawings are to provide convenience for description, and the size and thickness of each component are not necessarily limited to the size and thickness of each component illustrated in the drawings.

Features of the embodiments of the disclosure can be partially or entirely mixed or combined, and can technically link and operate in various ways, as one having ordinary skill in the art understands sufficiently. Further, each embodiment can be embodied independently, or in connection with each other.

Hereafter, optical sheets (a prism sheet and a diffusion sheet) and a display apparatus according to the present disclosure are described with reference to the accompanying drawings.

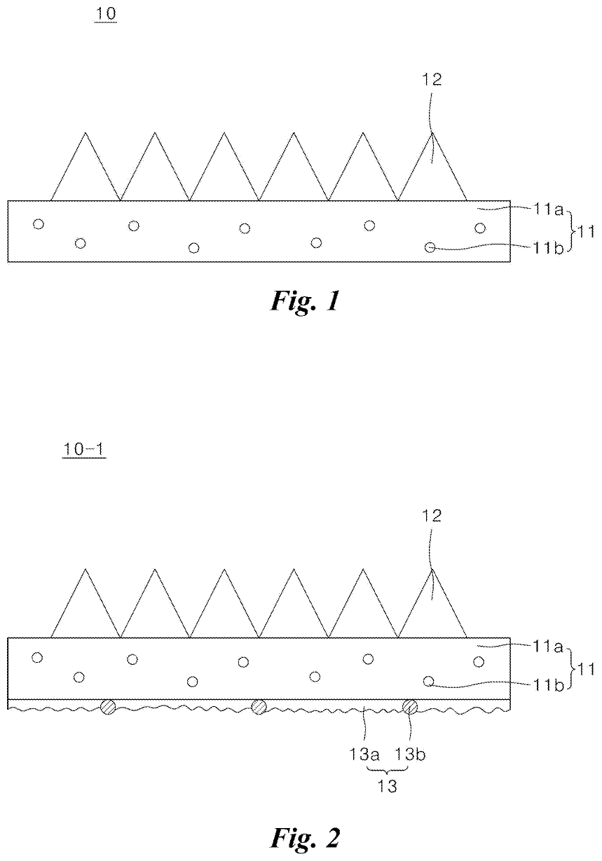

FIG. 1 is a view showing a prism sheet 10 according to one embodiment of the present disclosure.

Referring to FIG. 1, the prism sheet 10 comprises a support layer 11, and a plurality of prism patterns 12 disposed on the upper surface of the support layer 11.

The support layer 11 may be formed using a base resin 11a comprising a homo PET and a recycled copolymerized PET (Co-PET). The letters PET stand for polyethylene terephthalate.

A homo PET is formed by polymerizing ethylene glycol (EG) and terephthalic acid (TPA), and when necessary, diethylene glycol (DEG) may be added to the homo PET.

The homo PET formed by polymerizing ethylene glycol (EG) and terephthalic acid (TPA) may comprise an oligomer expressed as chemical formula 1 hereafter.

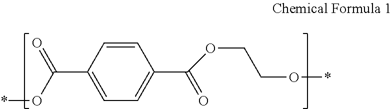

Additionally, a homo PET formed by polymerizing ethylene glycol (EG), terephthalic acid (TPA) and diethylene glycol (DEG) may comprise an oligomer expressed as chemical formula 2 hereafter as well as an oligomer expressed as the above chemical formula 1.

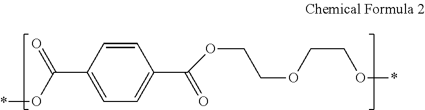

A recycled Co-PET is formed by recycling a copolymerized PET that is ordinarily used for a beverage container, and is formed by copolymerizing EG, TPA and isophthalic acid (IPA), and when necessary, cyclohexane dimethanol (CHDM) may be added to the recycled Co-PET.

The recycled Co-PET may comprise an oligomer expressed as chemical formula 3 hereafter that is formed by polymerizing EG and IPA as well as an oligomer expressed as the above chemical formula 1.

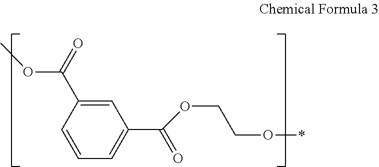

The base resin 11a may comprise 80 wt % or less of the recycled Co-PET. In the case where the base resin 11a comprises greater than 80 wt % of the recycled Co-PET, a support layer 11 having a desired thickness cannot be obtained, since the base resin 11a is not stretched.

As a desired thickness of the support layer 11 decreases, the content of the recycled Co-PET may decrease. If a desired thickness of the support layer 11 is 100 μm or less, it is preferable to adjust the content of the recycled Co-PET to 50 wt % or less.

The base resin 11a may comprise foreign substances 11b therein. For example, the foreign substances 11b may be a carbide.

The sizes of the foreign substances 11b are preferably 100 μm or less, considering a decrease in the transmittance of the prism sheet 10 and a change in the color coordinate of light having passed through the prism sheet 10.

Referring to table 1 hereafter, in the case where the sizes of the foreign substances 11b are 100 μm or less, the transmittance of the prism sheet 10 is 98% to 99%, and the Δy value of the color coordinate of light having passed through the prism sheet 10 is at a level of 0.005 or less. However, in the case where the sizes of the foreign substances 11b are greater than 100 μm, the transmittance of the prism sheet 10 drops to a level of 90%, and the Δy value of the color coordinate of light having passed through the prism sheet 10 increases to about 0.018. The transmittance and the color coordinate are measured in relation to blue light of a 450 nm wavelength.

TABLE 1

| Size of foreign substance | <50 μm | 100 μm | 150 μm | 200 μm |
|---|---|---|---|---|
| Transmittance (%) | 99 | 98 | 90 | 91 |
| Color coordinate (Δy) | +0.003 | +0.005 | +0.018 | +0.022 |

The prism patterns 12 may have a triangular cross section, extend along one direction, and may be arranged to be adjacent to each other in the other direction.

The prism patterns 12 may be made of elastic acryl, but not limited.

Referring to table 2 hereafter, the thermal contraction rate of a recycled PET film comprising a recycled Co-PET of one embodiment is less than the thermal contraction rate of an existing optical PET film only comprising a homo PET.

TABLE 2

| | | Existing | Recycled |
|---|---|---|---|
| | | optical | PET film |
| | | PET film | in embodiment |
| Recycling rate | wt % | 0 | 80 |
| Transmittance | % | 89.2 | 88.6 |
| Thermal contraction rate | MD (longitudinal | 0.15 | 0.12 |
| (85° C., 24 hr) | direction) | | |
| | TD (transverse | 0.15 | 0.11 |
| | direction) | | |

Accordingly, the prism sheet 10 according to one embodiment may ensure improvement in curl distortion, in a high-temperature environment and a high-temperature reliability environment.

Additionally, in the prism sheet 10 according to one embodiment, a base resin comprising the recycled Co-PET is used as the support layer, ensuring a reduction in the manufacturing costs of the prism sheet, and a contribution to recycling of resources and protection of the environment.

FIG. 2 is a view showing a prism sheet 10-1 according to one embodiment of the present disclosure.

Referring to FIG. 2, the prism sheet 10-1 comprises a support layer 11, a plurality of prism patterns 12 disposed on the upper surface of the support layer 11, and a back coating layer 13 disposed on the lower surface of the support layer 11.

The support layer 11 and the prism patterns 12 are the same as those described with reference to FIG. 1.

The back coating layer 13 may comprise beads 13b and a binder resin 13a for fixing the beads 13b. The binder resin 13a, for example, may be made of an acrylic resin having high resistance against a scratch.

The beads 13b may be made of a silicon oxide, polymethyl methacrylate (PMMA) and the like. The beads 13b may be comprised of PMMA, preferably.

In the case where beads 13b comprised of PMMA are coated on the lower surface of the support layer 11, the Δy value of the color coordinate of light having passed through the prism sheet 10-1 may decrease.

As described above, even in the case where the sizes of foreign substances 11b are 100 μm or less, the Δy value of the color coordinate of light having passed through the prism sheet 10 is about 0.005.

However, referring to table 3 hereafter, in the case where the beads 13b comprised of PMMA are coated on the lower surface of the support layer 11, the Δy value of the color coordinate of light having passed through the prism sheet 10-1 may decrease to a level of 0.002 or less.

TABLE 3

| | | Size of foreign substances | | | |
|---|---|---|---|---|---|
| Sort of beads | | <50 μm | 100 μm | 150 μm | 200 μm |
| Color | SiO2 | +0.003 | +0.005 | +0.018 | +0.022 |
| coordinate | TiO2 | +0.006 | +0.011 | +0.024 | +0.033 |
| (Δy) | PMMA | +0.001 | +0.002 | +0.011 | +0.015 |

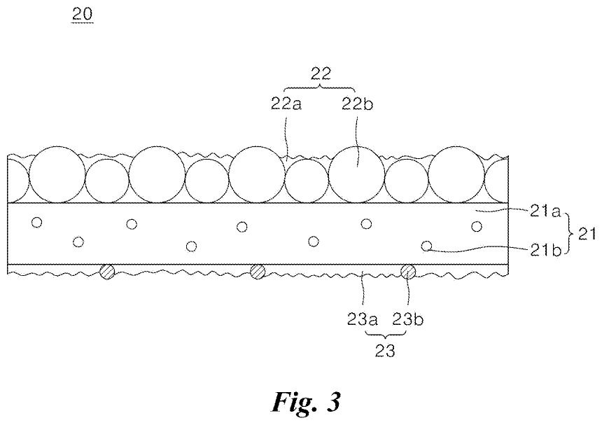

FIG. 3 is a view showing a diffusion sheet 20 according to one embodiment of the present disclosure.

Referring to FIG. 3, the diffusion sheet 20 comprises a support layer 21, a diffusion layer 22 disposed on the upper surface of the support layer 21, and a back coating layer 23 disposed on the lower surface of the support layer 21.

For the support layer 21, a base resin 21a comprising a homo PET and a recycled Co-PET may be used.

The homo PET is formed by polymerizing ethylene glycol (EG) and terephthalic acid (TPA), and when necessary, diethylene glycol (DEG) may be added to the homo PET.

The recycled Co-PET is formed by recycling a copolymerized PET that is ordinarily used as a beverage container, and is formed by copolymerizing EG, TPA, and IPA, and when necessary, CHDM is added to the recycled Co-PET.

The base resin 21a may comprise 80 wt % or less of the recycled Co-PET. In the case where the base resin 21a comprises greater than 80 wt % of the recycled Co-PET, the base resin 21a is not stretched, and thus a support layer 21 having a desired thickness cannot be obtained.

As a desired thickness of the support layer 21 decreases, the content of the recycled Co-PET may decrease. If a desired thickness of the support layer 21 is 100 μm or less, it is preferable to adjust the content of the recycled Co-PET to 50 wt % or less.

The base resin 21a may comprise foreign substances 21b therein. For example, the foreign substances 21b may be a carbide.

The sizes of the foreign substances 21b are preferably 100 μm or less, considering a decrease in the transmittance of the diffusion sheet 20 and a change in the color coordinate of light having passed through the diffusion sheet 20.

The diffusion layer 22 may comprise beads 22b for diffusing light, and a binder resin 22a for fixing the beads 22b.

The binder resin 22a, for example, may be made of an acrylic resin having high resistance against a scratch.

The beads 22b may be made of a transparent polymer material. For example, the beads 22b may be made of PMMA, polycarbonate (PC), methylstyrene (MS), polystyrene (PS) and the like that exhibit excellent optical properties. The beads 22b may be, for example, hollow beads to improve a light diffusion function.

The back coating layer 23 may comprise beads 23b and a binder resin 23a for fixing the beads 23b.

The binder resin 23a, for example, may be made of an acrylic resin having high resistance against a scratch.

The beads 23b may be made of a silicon oxide, PMMA and the like. The beads 23b are made of PMMA, preferably.

In the case where the beads 23b comprised of PMMA are coated on the lower surface of the support layer 21, the Δy value of the color coordinate of light having passed through the diffusion sheet 20 may decrease.

In the diffusion sheet 20 according to one embodiment, a base resin comprising a recycled Co-PET is used as the support layer, ensuring a reduction in the manufacturing costs of the diffusion sheet, and a contribution to recycling resources and protection of the environment.

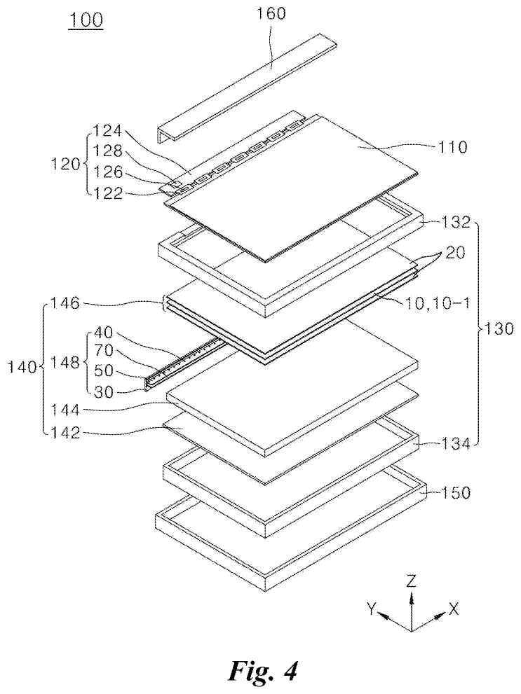

FIG. 4 is an exploded perspective view showing a display apparatus according to one embodiment of the present disclosure.

Referring to FIG. 4, a display apparatus 100 according to one embodiment comprises a liquid crystal panel 110, a panel driving part 120, a panel support part 130, a back light unit 140, an exterior case 150, and a front cover 160.

The liquid crystal panel 110 adjusts the light transmittance of a liquid crystal layer to display an image, and the liquid crystal panel 110 may comprise a lower substrate, an upper substrate, a liquid crystal layer among the lower substrate and the upper substrate, a lower polarizing member and an upper polarizing member. The liquid crystal panel 110 drives the liquid crystal layer, based on an electric field that is formed at each pixel by a data voltage and a common voltage supplied to each pixel, and displays a predetermined colorful image, based on the light transmittance of the liquid crystal layer.

The panel driving part 120 connects to a pad part provided at the lower substrate and drives each pixel of the liquid crystal panel 110, to display a predetermined colorful image on the liquid crystal panel 110. The panel driving part 120 according to one example comprises a plurality of circuit films 122 that connects to the pad part of the liquid crystal panel 110, a data driving integrated circuit 126 that is mounted on each of the plurality of circuit films 122, a printed circuit board 124 for a display, which is coupled to each of the plurality of circuit films 122, and a timing controller 128 that is mounted on the printed circuit board 124 for a display.

Each of the plurality of circuit films 122 may be attached between the pad part of the lower substrate and the printed circuit board 124 for a display by a film attachment process, and made of a tape carrier package (TCP) or a chip on flexible board or a chip on film (COF). Each of the plurality of circuit films 122 is bent along one side surface, i.e., the lower side surface, of the liquid crystal panel 110, and disposed on the rear surface of a guide frame 132.

The data driving integrated circuit 126 is respectively mounted on each of the plurality of circuit films 122 and connects to the pad part through the circuit film 122. The data driving integrated circuit 126 receives pixel data of each pixel and a data control signal that are supplied from the timing controller 128, and based on the data control signal, converts the pixel data of each pixel into a analogue-type data signal, and supplies the data signal to a corresponding data line through the pad part.

The printed circuit board 124 for a display connects to the plurality of circuit films 122. The printed circuit board 124 for a display provides a signal needed to display an image on each pixel of the liquid crystal panel 110 to the data driving integrated circuit 126 and a gate driving circuit. To this end, various types of signal wires, power circuits, memory elements and the like are mounted on the printed circuit board 124 for a display.

The timing controller 128 is mounted on the printed circuit board 124 for a display, arranges digital image data that are input from an external driving system in response to a timing synchronization signal supplied from an external driving system, to correspond to the pixel arrangement structure of the liquid crystal panel 110, generates pixel data of each pixel, and provides the generated pixel data of each pixel to the data driving integrated circuit 126. Additionally, the timing controller 128 generates a data control signal and a gate control signal respectively, based on the timing synchronization signal, and controls the driving timing of each of the data driving integrated circuit 126 and the gate driving circuit.

Further, the timing controller 128 controls the back light unit 140, through edge local dimming technologies, to control the luminance of each area of the liquid crystal panel 110 individually.

The panel support part 130 comprises a guide frame 132 and a storage case 134.

The guide frame 132 supports the liquid crystal panel 110 from the lower portion of the liquid crystal panel 110.

The storage case 134 supports the guide frame 132 as well as accommodating the back light unit 140.

The back light unit 140 is disposed under the liquid crystal panel 110 and irradiates light to the lower surface of the liquid crystal panel 110. At this time, the back light unit 140 is accommodated in the storage case 134. The back light unit 140 according to one example may comprise a reflection sheet 142, a light guide plate 144, an optical sheet part 146, and a light source module 148.

The reflection sheet 142 is disposed on the lower surface of the light guide plate 144, and reflects light incident from the light guide plate 144 toward the light guide plate 144, to minimize the loss of light traveling to the rear surface of the light guide plate 144.

The light guide plate 144 has a flat or wedge shaped light incident surface that is provided on a first lateral surface of the light guide plate 144, and allows light input from the light source module 148 through the light incident surface to process toward the liquid crystal panel 110.

The optical sheet part 146 is disposed on the light guide plate 144, and comprises a lower diffusion sheet, a prism sheet and an upper diffusion sheet, but is not limited.

For example, the optical sheet part 146 may comprise a prism sheet 10, 10-1 of FIG. 1 or 2, and may comprise diffusion sheets 20 of FIG. 3, which are disposed on and under the prism sheet 10, 10-1.

The light source module 148 is disposed to face the first lateral surface of the light guide plate 144, and emits light to the light incident surface that is provided on one lateral surface of the light guide plate 144. The light source module 148 of an example comprises a plurality of light sources 40 that is mounted on a printed circuit board for a light source 30, emits light, based on a light source part driving signal supplied from a back light driving part, and emits white light, a lens housing 50, and a lend array 70. The lens housing 50 is disposed on the lateral surface of the plurality of light sources 40, and guides light emitted from the light source 40 to the lateral surface of the light guide plate 144, and the lens array 70 diffuses the light emitted from the light source 40.

The exterior case 150 surrounds the lateral surface of the guide frame 132 while accommodating the storage case 134, to form the exterior of the display apparatus.

The front cover 160 is coupled to the guide frame 132, to cover the edge portion of one side of the liquid crystal panel 110. The front cover 160 hides the panel driving part 120 that connects to the edge portion of one side of the liquid crystal panel 110.

The display apparatus of one embodiment comprises a prism sheet and a diffusion sheet where a base resin comprising a recycled Co-PET is used as a support layer, ensuring a reduction in manufacturing costs of the display apparatus and a contribution to recycling of resources and protection of the environment.

The prism sheet, the diffusion sheet and the display apparatus of the embodiments can be described as follows.

The prism sheet of the embodiment comprises a support layer, and prism patterns disposed on the upper surface of the support layer, and the support layer may be comprised of a base resin comprising a homo PET and a recycled Co-PET.

In several embodiments, the base resin may comprise 80 wt % or less of a recycled Co-PET.

In several embodiments, the recycled Co-PET may comprise at least one of isophthalic acid (IPA) and cyclohexanedimethanol (CHDM).

In several embodiments, foreign substances may be included in the base resin, and have a size of 100 μm or less.

In several embodiments, the prism sheet may further comprise a back coating layer that is disposed on the lower surface of the support layer and that comprises beads and a binder resin for fixing the beads, and the beads may be comprised of polymethyl methacrylate (PMMA).

The diffusion sheet of the embodiment comprises a support layer, and a diffusion layer that is disposed on the upper surface of the support layer and comprises beads, and the support layer may be comprised of a base resin that comprises a homo PET and a recycled Co-PET.

In several embodiments, the base rein may comprise 80 wt % or less of the recycled Co-PET.

In several embodiments, the recycled Co-PET may comprise at least one of IPA and CHDM.

In several embodiments, foreign substances may be included in the base resin, and have a size of 100 μm or less.

In several embodiments, the diffusion layer further comprises a back coating layer that is disposed on the lower surface of the support layer and that comprises beads and a binder resin for fixing the beads, and the beads may be comprised of PMMA.

The display apparatus of the embodiment comprises a liquid crystal panel, and a back light unit that is disposed under the liquid crystal panel and comprises at least one of optical sheets, and at least one of the optical sheets may comprise a prism sheet of one embodiment or a diffuse sheet of one embodiment.

In several embodiments, at least one of the optical sheets may comprise a prism sheet of one embodiment, and a diffusion sheet of one embodiment, which is disposed respectively on and under the prism sheet.

The embodiments of the present disclosure are described above with reference to the accompanying drawings. However, embodiments are not limited to the embodiments set forth herein, and can be modified in various different forms within the technical spirit of the disclosure. It is to be understood that the embodiments set forth herein are provided as examples to describe the technical spirit of the disclosure rather than limiting the technical spirit of the disclosure and are not intended to limit the scope of the technical spirit.

The various embodiments described above can be combined to provide further embodiments. All of the U.S. patents, U.S. patent application publications, U.S. patent applications, foreign patents, foreign patent applications and non-patent publications referred to in this specification and/or listed in the Application Data Sheet are incorporated herein by reference, in their entirety. Aspects of the embodiments can be modified, if necessary to employ concepts of the various patents, applications and publications to provide yet further embodiments.

These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. A prism sheet, comprising:
a support layer having an upper surface and a lower surface opposite the upper surface, the support layer having a base resin; and
prism patterns on the upper surface of the support layer,
wherein the base resin includes a homo PET and a recycled copolymerized PET (Co-PET).

2. The prism sheet of claim 1, wherein the base resin comprises 80 wt % or less of the recycled Co-PET.

3. The prism sheet of claim 1, wherein the recycled Co-PET comprises at least one of isophthalic acid (IPA) and cyclohexane dimethanol (CHDM).

4. The prism sheet of claim 1, where foreign substances are included in the base resin, and the foreign substances have a size of 100 μm or less.

5. The prism sheet of claim 1, further comprising a back coating layer being on the lower surface of the support layer and comprising beads and a binder resin for fixing the beads, and the beads are comprised of polymethyl methacrylate (PMMA).

6. A diffusion sheet, comprising:
a support layer having an upper surface and a lower surface opposite the upper surface, the support layer having a base resin; and
a diffusion layer on the upper surface of the support layer and comprising beads, wherein the base resin includes a homo PET and a recycled Co-PET.

7. The diffusion sheet of claim 6, wherein the base resin comprises 80 wt % or less of the recycled Co-PET.

8. The diffusion sheet of claim 6, wherein the recycled Co-PET comprises at least one of isophthalic acid (IPA) and cyclohexane dimethanol (CHDM).

9. The diffusion sheet of claim 6, wherein foreign substances are included in the base resin, and the foreign substances have a size of 100 μm or less.

10. The diffusion sheet of claim 6, further comprising a back coating layer being on the lower surface of the support layer and comprising beads and a binder resin for fixing the beads, and the beads are comprised of polymethyl methacrylate (PMMA).

11. A display apparatus, comprising:
a liquid crystal panel; and
a back light unit being disposed under the liquid crystal panel and comprising at least one of optical sheets,
wherein at least one of the optical sheets includes at least one of a prism sheet or a diffusion sheet, the prism sheet including:
a support layer having an upper surface and a lower surface opposite the upper surface, the support layer having a base resin; and
prism patterns on the upper surface of the support layer,
wherein the base resin includes a homo PET and a recycled copolymerized PET (Co-PET).

12. The display apparatus of claim 11, wherein the base resin comprises 80 wt % or less of the recycled Co-PET.

13. The display apparatus of claim 11, wherein the recycled Co-PET comprises at least one of isophthalic acid (IPA) and cyclohexane dimethanol (CHDM).

14. The display apparatus of claim 11, where foreign substances are included in the base resin, and the foreign substances have a size of 100 μm or less.

15. The display apparatus of claim 11, wherein the prism sheet further comprises a back coating layer being on the lower surface of the support layer and comprising beads and a binder resin for fixing the beads, and the beads are comprised of polymethyl methacrylate (PMMA).

16. The display apparatus of claim 11, wherein the diffusion sheet includes:
a second support layer having an upper surface and a lower surface opposite the upper surface, the second support layer having a second base resin; and
a diffusion layer on the upper surface of the second support layer and comprising beads, wherein the second base resin includes a homo PET and a recycled Co-PET.

17. The display apparatus of claim 16, wherein the second base resin comprises 80 wt % or less of the recycled Co-PET.

18. The display apparatus of claim 16, wherein the recycled Co-PET of the second base resin comprises at least one of isophthalic acid (IPA) and cyclohexane dimethanol (CHDM).

19. The display apparatus of claim 16, wherein the diffusion sheet further comprises a second back coating layer being on the lower surface of the second support layer and comprising beads and a binder resin for fixing the beads, and the beads are comprised of polymethyl methacrylate (PMMA).

20. The display apparatus of claim 16, wherein at least one of the optical sheets comprises the prism sheet and the diffusion sheet being disposed respectively on and under the prism sheet.
